(19) United States
(12) Patent Application Publication
(10) Pub. No.: US 2013/0155072 A1
(43) Pub. Date: Jun. 20, 2013

(54) ELECTRONIC DEVICE AND METHOD FOR MANAGING FILES USING THE ELECTRONIC DEVICE

(71) Applicant: HSIEN-CHUN CHIU, Shindian (TW)

(72) Inventor: HSIEN-CHUN CHIU, Shindian (TW)

(73) Assignee: FIH (HONG KONG) LIMITED, Kowloon (HK)

(21) Appl. No.: 13/451,448

(22) Filed: Apr. 19, 2012

(30) Foreign Application Priority Data
Dec. 16, 2011 (TW) 100146904

(51) Int. Cl. G06T 13/00; G06F 3/033; G06F 3/041

(52) U.S. Cl. 345/473; 345/173

(57) ABSTRACT

A method for managing files using an electronic device determines a target storage path in the electronic device in response to detecting a selection operation of the target storage path on a touch panel of the electronic device. A copy operation on a target file displayed on the touch panel is detected, while the selection operation is being implemented. The target file is stored at the target storage path, and an animated cartoon is output on the touch panel to represent a process of storing the target file to the target storage path.

### BACKGROUND

1. Technical Field

Embodiments of the present disclosure relate to data management technology, and particularly to an electronic device and method for managing files using the electronic device.

2. Description of Related Art

Many kinds of electronic devices (e.g., cell phones, tablet computers) have touch panels to input or output relevant data. An electronic device may store a plurality of files. When a user needs to manage the files through operations on the touch panel, such as to remove a file from an original storage path to a target storage path, the user has to execute a copy operation, a paste operation, a cutting operation, or a dragging operation to drag the file to the target storage path. This is inconvenient and time consuming.

### BRIEF DESCRIPTION OF THE DRAWINGS

FIG. 1 is a block diagram of one embodiment of an electronic device including a file management system.

FIG. 2 is a schematic diagram of one embodiment of a multi-touch operation on a touch panel of the electronic device of FIG. 1.

FIG. 3 is a schematic diagram of one embodiment of a double-click operation on the touch panel of the electronic device of FIG. 1.

FIG. 4 is a schematic diagram of one embodiment of a slide operation on the touch panel of the electronic device of FIG. 1.

FIG. 5 is a flowchart of one embodiment of a method for managing files using the file management system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

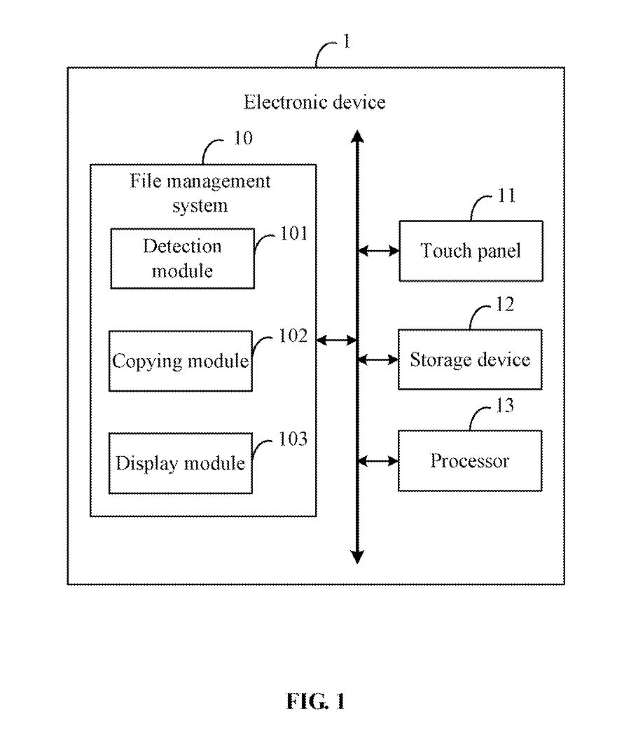

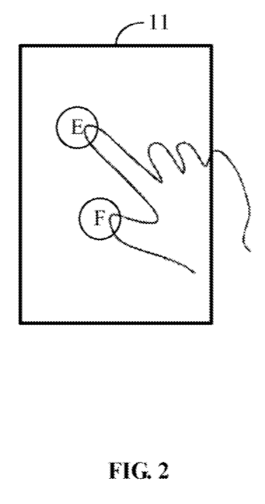

FIG. 1 is a block diagram of one embodiment of an electronic device 1 including a file management system 10. The electronic device 1 may be a cell phone, a personal digital assistant, a tablet computer, or any other computing device. The electronic device 1 includes a touch panel 11. The touch panel 11 is used to input and output relevant data, such as images, files, for example. In some embodiments, the touch panel 11 may be a capacitive touch panel or a resistive touch panel that offers a multi-touch capability. Multi-touch refers to a touch sensing surface's (e.g., the touch panel 11) ability to recognize presences of two or more points of contact with the surface. As shown in FIG. 2, the touch panel 11 may detect simultaneous contact operations on points E and F.

In some embodiments, the file management system 10 predetermines control operations (e.g., a selection operation and a copy operation for managing files, detailed descriptions are provided below) that are used to copy files stored in the electronic device 1. The file management system 10 copies a target file from an original storage path to a designated storage path in response to detecting the predetermined control operations on the touch panel 11. The predetermined operations utilize the multi-touch capability of the touch panel 11. A detailed description of the file management system 10 will be given in the following paragraphs.

The electronic device 1 further includes a storage device 12 providing one or more memory functions, and at least one processor 13. In one embodiment, the file management system 10 may include computerized instructions in the form of one or more programs that are executed by the at least one processor 13 and stored in the storage device 12. The storage path may be a path in the storage device 12.

The storage device 12 stores one or more programs, such as programs of the operating system, other applications of the electronic device 1, and various kinds of data, such as videos and files. In some embodiments, the storage device 12 may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In one embodiment, the file management system 10 may include one or more modules, for example, a detection module 101, a copying module 102, and a display module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The detection module 101 may detect a selection operation on the touch panel 11 to select a target storage path. The selection operation may be predetermined by the detecting module 101. In some embodiments, the selection operation of the target storage path may be a press operation on the target storage path for a predetermined time (e.g., 5 seconds). For example, the target storage path may be a target folder, a desktop path, a recycle bin of the electronic device 1, or other storage path in the electronic device 1. The user may click or press the target folder using a finger for the predetermined time, to select the target, in one example.

The detection module 101 determines the target storage path in response to detecting the selection operation of the target storage path.

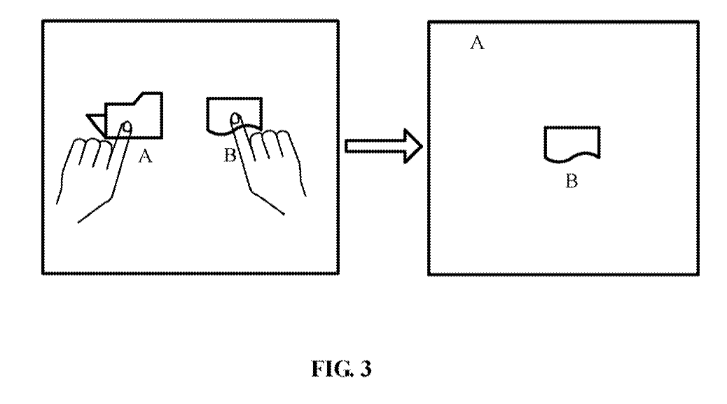

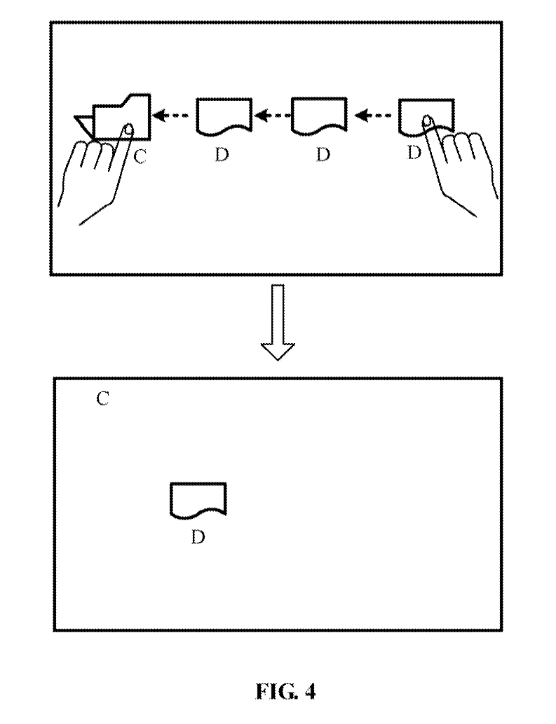

The detection module 101 detects a copy operation on a target file displayed on the touch panel 11 while the selection operation is being implemented (detailed descriptions are provided below). The copy operation may be predetermined by the detection module 101. In some embodiments, the copy operation of the target file is a double-click operation on the target file displayed on the touch panel 11, a flip operation to flip the target file over the touch panel 11, or a slide operation to slide the target file over the touch panel 11. The copy operation is implemented using the finger or the stylus. Detailed descriptions on the copy operation are provided below (see FIG. 3 and FIG. 4).

The selection operation of the target storage path is implemented by a first finger or a first stylus, and the copy operation on the target file is implemented by a second finger or a second stylus while the selection operation is still implemented using the first finger or the first stylus. For example, the user may use the first finger or the first stylus to press a folder displayed on the touch panel 11 for the predetermined time to determine that the folder is the target folder, and then use the second finger or the second stylus to double-click, flip or slide a file while the first finger or the first stylus is still pressing the target folder. The file is regarded as the target file that needs to be copied to the target folder.

The copying module 102 copies/stores the target file to the target storage path. If the target storage path refers to the target folder, the target file is copied to the target folder by the copying module 102. If the target storage path is the desktop path, the target file is copied to the desktop path and displayed on a desktop of the electronic device 1. If the target storage path is the recycle bin, the target file is deleted from an original storage path.

In some embodiments, when copying/storing the target file to the target storage path, the copying module 102 may keep storing the target file at the original storage path of the target file, or deletes the target file from the original storage path, according to presetting by the copying module 102.

The display module 103 outputs an animated cartoon on the touch panel 11 to represent a process of storing the target file to the target storage path (e.g., the target folder). In some embodiments, the display module 103 may display a plurality of icons of the target file in sequence during copying the target file to the target folder. As shown in FIG. 4, multiple icons of a target file “D” are displayed in sequence until the target file “D” is copied to a target folder “C”.

FIG. 3 provides a schematic diagram of the double-click operation. First, the target storage path, such as a target folder “A” shown in FIG. 3, is selected by pressing the target folder “A” for the predetermined time using the detection module 101. Then, the detection module 101 further detects the double-click operation on a target file “B” while the selection operation of the target folder “A” is being implemented. The copying module 102 copies the target file “B” to the target folder “A”.

FIG. 4 is a schematic diagram of one embodiment of the slide operation on the touch panel 11. The target folder “C” is selected by pressing for the predetermined time, and the target file “D” is removed to the target folder “C” by detecting the slide operation on the target file “D”. The display module 103 displays a plurality of icons of the target file “D” during a coping process of the target file “D” to the target folder “C”.

The flip operation (not shown in Figures) represents an operation that presses the target file first, then flips the target file in an arc shape manner In some embodiments, the flip operation and the slide operation may be made in any direction. That is, when the flip operation or the slide operation is implemented on the target file, it is not needed to flip or slide the target file towards the target storage path (e.g., the target folder).

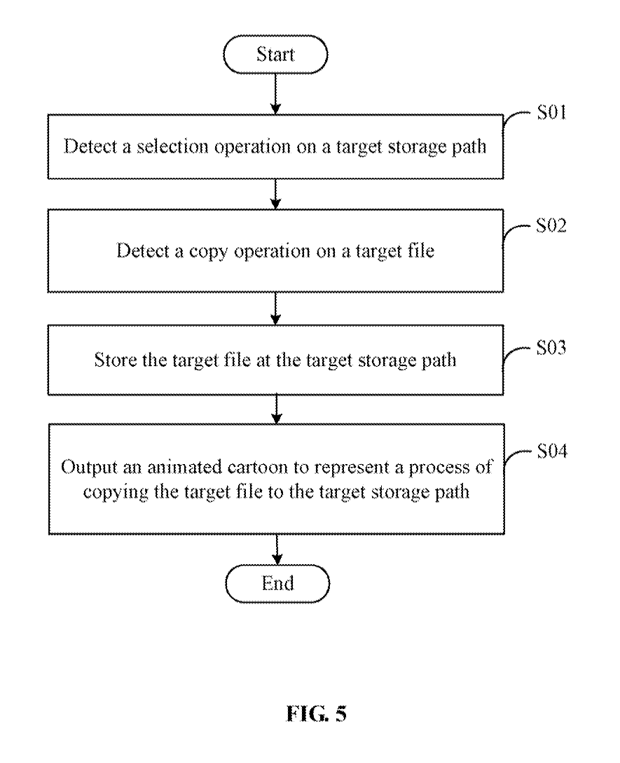

FIG. 5 is a flowchart of one embodiment of a method for managing files using the file management system 10 of FIG. 1. Depending on the embodiment, additional steps may be added, others removed, and the ordering of the steps may be changed.

In step S01, the detection module 101 detects a selection operation on the touch panel 11 to select a target storage path, and determines the target storage path in response to detecting the selection operation of the target storage path. As mentioned above, the selection operation of the target storage path may be a press operation on the target storage path for a predetermined time (e.g., 5 seconds).

In step S02, the detection module 101 detects a copy operation on a target file displayed on the touch panel 11 while the selection operation is being implemented. As mentioned above, the copy operation of the target file is a double-click operation on the target file, a flip operation to flip the target file, or a slide operation to slide the target file.

In step S03, the copying module 102 copies/stores the target file to the target storage path.

In step S04, the display module 103 outputs an animated cartoon on the touch panel 11 to represent a process of copying the target file to the target storage path (e.g., the target folder). As mentioned above, the display module 103 may display a plurality of icons of the target file in sequence during copying the target file to the target folder.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for managing files using an electronic device comprising a processor and a touch panel, the method comprising execution of the steps comprising:
determining a target storage path in a storage device of the electronic device in response to detecting a selection operation of the target storage path on the touch panel;
detecting a copy operation on a target file displayed on the touch panel while the selection operation is being implemented;
storing the target file to the target storage path; and
outputting an animated cartoon on the touch panel, the animated cartoon representing a process of storing the target file to the target storage path.

2. The method according to claim 1, wherein the selection operation of the target storage path is implemented by a first finger or a first stylus, and the copy operation on the target file is implemented by a second finger or a second stylus while the selection operation is still implemented using the first finger or the first stylus.

3. The method according to claim 1, wherein the selection operation of the target storage path is a press operation on the target storage path displayed on the touch panel for a predetermined time using a first finger or a first stylus.

4. The method according to claim 1, wherein the copy operation of the target file is a double-click operation on the target file displayed on the touch panel, a flip operation to flip the target file over the touch panel, or a slide operation to slide the target file over the touch panel, by using a second finger or a second stylus.

5. The method according to claim 1, wherein the animated cartoon is output on the touch panel by displaying a plurality of icons of the target file in sequence during the process of storing the target file to the target storage path.

6. The method according to claim 1, further comprising:
determining an original storage path of the target file; and
deleting the target file from the original storage path.

7. An electronic device, comprising:
a touch panel;
a storage device;
at least one processor; and
one or more modules that are stored in the storage device and executed by the at least one processor, the one or more modules comprising:
a detection module that determines a target storage path in the storage device of the electronic device in response to detecting a selection operation of the target storage path on the touch panel, and detects a copy operation on a target file displayed on the touch panel while the selection operation is being implemented;
a copying module that store the target file to the target storage path; and
a display module that outputs an animated cartoon on the touch panel, the animated cartoon representing a process of storing the target file to the target storage path.

8. The electronic device according to claim 7, wherein the selection operation of the target storage path is implemented by a first finger or a first stylus, and the copy operation on the target file is implemented by a second finger or a second stylus while the selection operation is still implemented using the first finger or the first stylus.

9. The electronic device according to claim 7, wherein the selection operation of the target storage path is a press operation on the target storage path displayed on the touch panel for a predetermined time using a first finger or a first stylus.

10. The electronic device according to claim 7, wherein the copy operation of the target file is a double-click operation on the target file displayed on the touch panel, a flip operation to flip the target file over the touch panel, or a slide operation to slide the target file over the touch panel, by using a second finger or a second stylus.

11. The electronic device according to claim 7, wherein the animated cartoon is output on the touch panel by displaying a plurality of icons of the target file in sequence during the process of storing the target file to the target storage path.

12. The electronic device according to claim 7, wherein the copying module further determines an original storage path of the target file, and deletes the target file from the original storage path.

13. A non-transitory storage medium having stored instructions that, when executed by a processor of an electronic device, causes the electronic device to perform a method for managing files, the electronic device comprising a touch panel, the method comprising:
determining a target storage path in a storage device of the electronic device in response to detecting a selection operation of the target storage path on the touch panel;
detecting a copy operation on a target file displayed on the touch panel while the selection operation is being implemented;
storing the target file to the target storage path; and
outputting an animated cartoon on the touch panel, the animated cartoon representing a process of storing the target file to the target storage path.

14. The non-transitory storage medium according to claim 13, wherein the selection operation of the target storage path is implemented by a first finger or a first stylus, and the copy operation on the target file is implemented by a second finger or a second stylus while the selection operation is still implemented using the first finger or the first stylus.

15. The non-transitory storage medium according to claim 13, wherein the selection operation of the target storage path is a press operation on the target storage path displayed on the touch panel for a predetermined time using a first finger or a first stylus.

16. The non-transitory storage medium according to claim 13, wherein the copy operation of the target file is a double-click operation on the target file displayed on the touch panel, a flip operation to flip the target file over the touch panel, or a slide operation to slide the target file over the touch panel, by using a second finger or a second stylus.

17. The non-transitory storage medium according to claim 13, wherein the animated cartoon is output on the touch panel by displaying a plurality of icons of the target file in sequence during the process of storing the target file to the target storage path.

18. The non-transitory storage medium according to claim 13, wherein the method further comprises:
determining an original storage path of the target file; and
deleting the target file from the original storage path.
